(19) United States
(12) Patent Application Publication
(10) Pub. No.: US 2012/0300673 A1
(43) Pub. Date: Nov. 29, 2012

(54) DECENTRALISED COORDINATION ALGORITHM FOR MINIMISING CONFLICT AND MAXIMISING COVERAGE IN SENSOR NETWORKS

(75) Inventors: Ruben Stranders, Southampton (GB); Alexander Carl Rogers, Brockenhurst (GB); Nicholas Robert Jennings, Bishops Waltham (GB)

(73) Assignee: BAE SYSTEMS plc, London (GB)

(21) Appl. No.: 13/576,891

(22) PCT Filed: Jan. 18, 2011
(86) PCT No.: PCT/GB2011/050071

§ 371 Date: Aug. 2, 2012

(30) Foreign Application Priority Data
Feb. 3, 2010 (GB) 1001732.5

(51) Int. Cl. H04L 12/28

(52) U.S. Cl. 370/254

(57) ABSTRACT

A method of creating a sensor network from a plurality of sensing devices that includes identifying a plurality of subsets of the sensing devices, each of the subsets providing a preferred (e.g., desired or specified) sensing quality coverage. Communication signal strengths of the sensing devices in the subsets are adjusted to seek to enable direct or indirect communication between active sensing devices in all of the plurality of subsets, thereby creating a sensor network.

The present invention relates to sensor networks.

The use of wireless micro-sensor networks has generated a significant amount of interest in areas such as climate change research, weather and tidal surge prediction and monitoring intelligent buildings. These networks consist of cheap sensors with very limited computational capabilities; potentially, they can be deployed by scattering them from airplanes or ground vehicles. Taken to the extreme, these sensors could even become the size of a grain of sand or even dust, in which case they are also referred to as “smartdust”.

Due to the limitations caused by their constrained computational resources, these sensors need simple and robust algorithms for controlling various aspects of the network. Centralised control of such aspects is often not possible, and can introduce a single point of failure. Assigning radio frequencies (or, equivalently, time slots for the Time Division Multiple Access protocol) to sensors such that the number of required retransmissions due to interference is minimised (and data throughput is maximised) is a major challenge, particularly in large wireless sensor networks.

The frequency assignment problem has been addressed by the development of various message-passing algorithms. However, these known algorithms either produce approximate solutions or require exponential computation and communication. These properties push these algorithms beyond the limited computational and communicational abilities of micro-sensors, or require the use of a large number of frequencies, which reduces the bandwidth of the network.

Embodiments of the present invention are intended to address the problems outlined above.

According to one aspect of the present invention there is provided a method of creating a sensor network from a plurality of sensing devices, the method including:

identifying a plurality of subsets of the sensing devices, each of the subsets providing a preferred sensing quality coverage, and

adjusting communication signal strengths of the sensing devices in the subsets to seek to enable direct or indirect communication between active said sensing devices in all of the plurality of subsets, thereby creating a sensor network.

The step of identifying a said subset including a first said sensing device can include identifying two neighbouring said sensing devices of the first sensing device. The subset including the first sensing device and the two neighbouring sensing devices may comprise a clique.

The method may include identifying one of the sensing devices within the subset (or clique) that is determined to be dominated by the other two sensing devices in the subset, and deactivating the dominated sensing device (for network communications at least).

A said sensing device may be determined to be dominated if a sensing quality coverage provided by a pair consisting of the two other sensing devices in the subset is greater than a sensing quality coverage provided by a pair consisting of the first-mentioned sensing device and either of the two other sensing devices in the subset.

The preferred sensing quality coverage may comprise a subset having one said sensing device that is dominated by the two other said sensing devices in the subset.

A said subset may be represented by a triangle-free sub-graph of a connectivity graph representing the plurality of sensing devices. The method may further include allocating frequencies to the sensing devices in each said subset. The frequencies allocated to the sensing devices may be selected from a set comprising six different frequencies, with each of the sensing devices being allocated a particular one of the frequencies.

The step of adjusting communications ranges of the sensing devices can include at least one of the sensing devices incrementally increasing a strength of its communication signal (within its maximum range) until the sensing device detects that it and a neighbouring said sensing device share a common further neighbouring sensing device, and then reversing/undoing a preceding said incremental increase of the signal strength of the sensing device.

If a said non-dominated sensing device detects that a neighbouring said sensing device has failed then a state of the (non-failed) sensing device can be set as undecided instead of non-dominated so that its state can be re-determined by the method.

According to another aspect of the present invention there is provided a sensor network system comprising a plurality of sensing devices, wherein at least some of the sensing devices include:

a processor configured to identify a plurality of subsets of the sensing devices, each of the subsets providing a preferred sensing quality coverage, and

a processor configured to adjust communication signal strengths of the sensing devices in the subsets to seek to enable direct or indirect communication between active said sensing devices in all of the plurality of subsets, thereby creating a sensor network.

The system may not include a centralised controller that can have perfect knowledge of coverage and states of the sensing devices.

According to a further aspect of the present invention there is provided a sensing device including a processor configured to:

identify a subset including the sensing device and at least one other sensing device, the subsets providing a preferred sensing quality coverage, and

adjust a communication signal strength of the sensing devices to seek to enable direct or indirect communication between active said sensing devices in a plurality of subsets of sensing devices, thereby creating a sensor network.

According to yet another aspect of the present invention there is provided a computer program product comprising computer readable medium, having thereon computer program code means, when the program code is loaded, to make the computer execute a method substantially as described herein.

According to another aspect of the present invention there is provided a method of selecting sensors for use in a sensor network, the method including identifying subsets of sensors from a plurality of sensors, each said subset having a connectivity graph that is triangle-free.

The method may further include identifying second subsets of said sensors from the first subsets that avoid indirect frequency interference collision. The second subset may have a connectivity graph that comprises a square of the connectivity graph of the first set.

Embodiments of the present invention can be based on a decentralised coordination technique that activates only a subset of the deployed agents, subject to the connectivity graph of this subset being provably 3-colourable in linear time, hence allowing the use of a simple decentralised graph colouring algorithm. The technique can maximise the sensing coverage achieved by the selected sensing agents, which is given by an arbitrary non-decreasing submodular set function.

The approach used by specific embodiments differs from the conventional: instead of solving a graph colouring problem in the original sensor network, a novel decentralised coordination technique that deactivates certain sensors within the network is used, such that the resulting connectivity graph is more easily colourable. The technique can construct a triangle-free graph, which does not contain cliques of size greater than 2. This is appealing because it is a known result that these types of graphs are 3-colourable in linear time. Equally important, this bounds the number of required frequencies, which can be very large for the original sensor network. This approach poses the problem of how to select those sensors which should be deactivated to ensure that the resulting sensor network has maximum coverage. The present inventors realise that the problem of selecting a triangle-free sensor network that maximises coverage is NP-hard and have developed an approximate technique that can allow sensors to coordinate in a fully decentralised fashion to build a triangle-free algorithm with high sensing coverage.

Specific embodiments of the technique can activate a subset of the available sensors so as to maximise sensing coverage given by an arbitrary submodular set function, subject to the connectivity graph being triangle-free. A centralised greedy algorithm based on the notion of submodular independence systems can be used to derive a theoretical lower bound of 1/7 on the approximation ration of the algorithm, for any submodular function. This can act as a benchmark for the decentralised technique in empirical evaluations. Dynamic counterparts for these two techniques capable of dealing with failing sensors and new sensors, while ensuring the triangle-free property of the graphs, are also disclosed.

Whilst the invention has been described above, it extends to any inventive combination of features set out above or in the following description. Although illustrative embodiments of the invention are described in detail herein with reference to the accompanying drawings, it is to be understood that the invention is not limited to these precise embodiments. As such, many modifications and variations will be apparent to practitioners skilled in the art. Furthermore, it is contemplated that a particular feature described either individually or as part of an embodiment can be combined with other individually described features, or parts of other embodiments, even if the other features and embodiments make no mention of the particular feature. Thus, the invention extends to such specific combinations not already described.

The invention may be performed in various ways, and, by way of example only, embodiments thereof will now be described, reference being made to the accompanying drawings in which:

FIG. 1 illustrates schematically a plurality of sensing devices, each device including a processor;

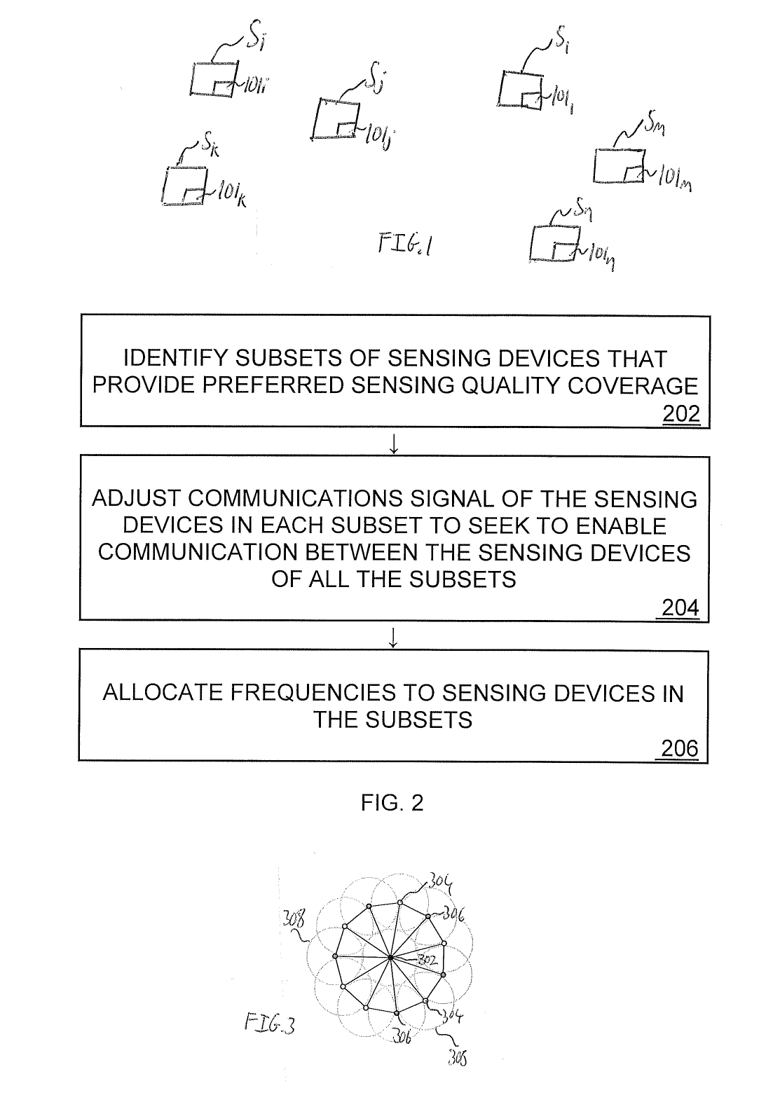

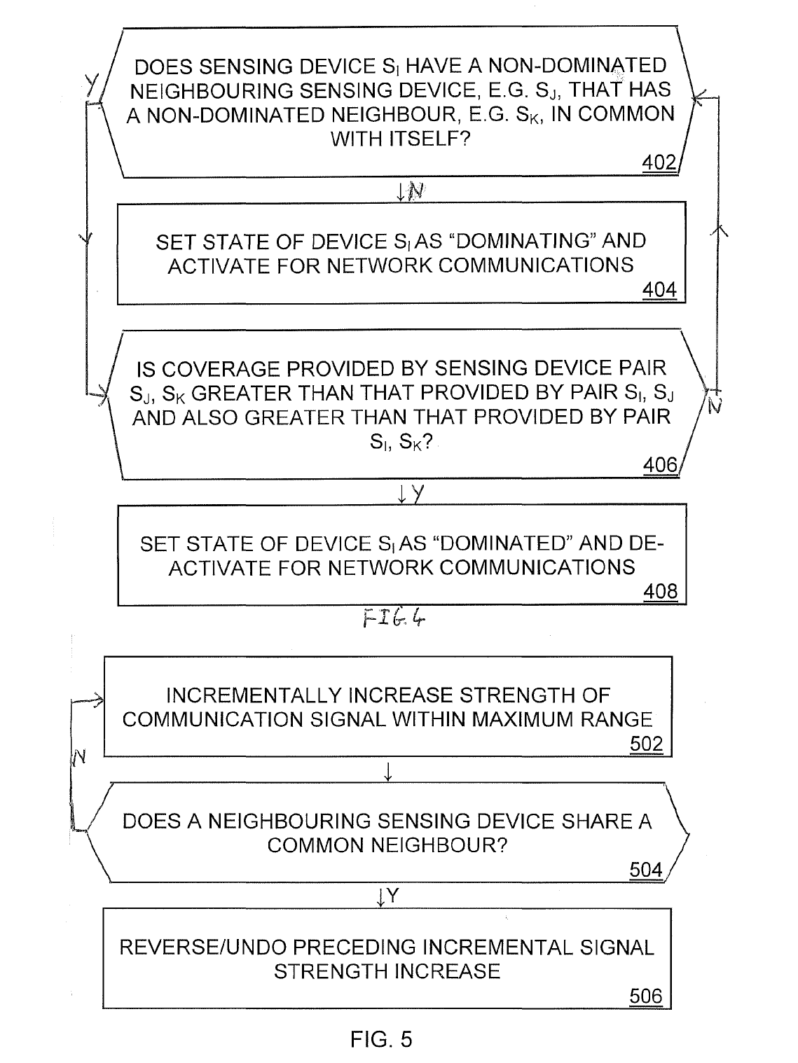

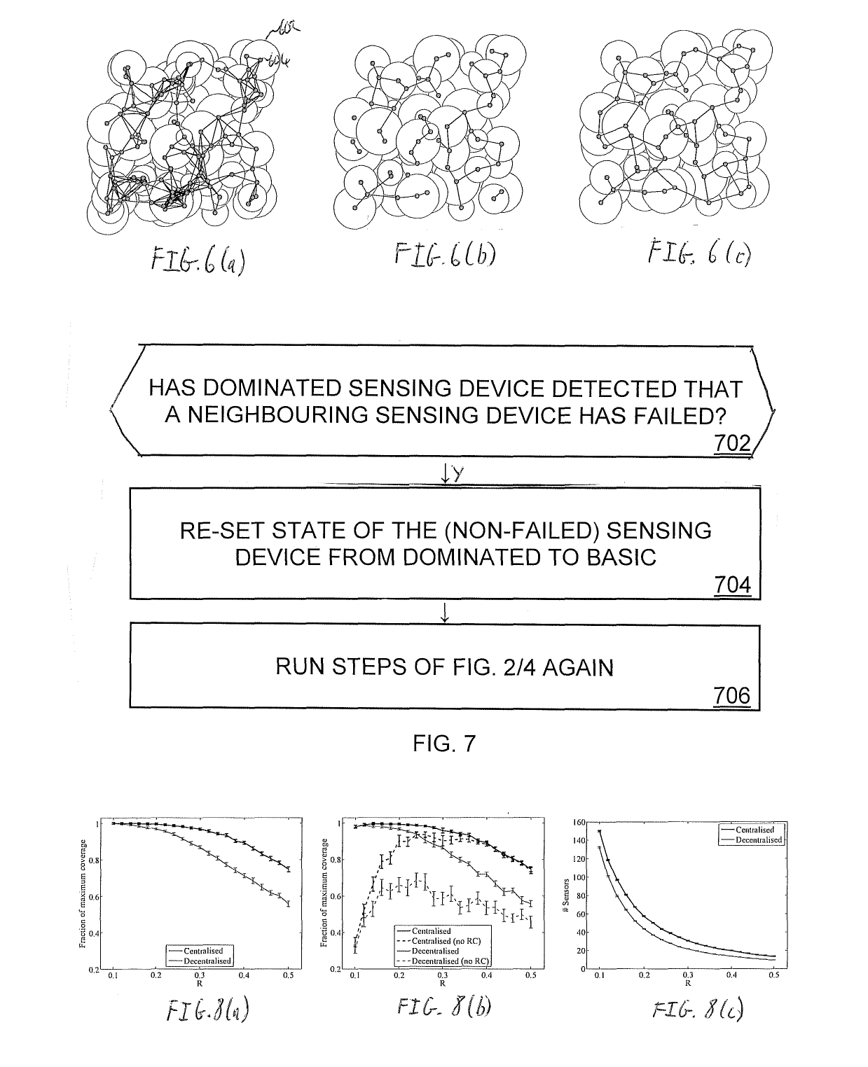

FIG. 2 is a high-level flowchart showing steps that can be performed by each sensing device in order create a sensor network;

FIG. 3 is a visual representation of a proof associated with the sensor network method;

FIG. 4 is a flowchart detailing steps in the method that identifies subsets of sensing devices;

FIG. 5 is a flowchart detailing steps in the method involving reconnection technique;

FIGS. 6(a)-6(c) illustrate examples of the execution of the technique of FIG. 2;

FIG. 7 is a flowchart detailing steps in the method that deals with failed sensing devices, and

FIGS. 8(a)-8(c), 9(a)-9(c), 10, 11(a)-11(c), 12 and 13 are graphs relating to results of an experimental implementation of the system.

FIG. 1 illustrates a plurality of sensing devices Sᵢ, Sⱼ, Sₖ, Sₗ, Sₘ, Sₙ. Six devices are shown in the example for ease of illustration, but it will be appreciated that the number and type (e.g. RADAR, LIDAR, or image-based) of sensing devices can vary. Each sensing device is capable of taking at least one sensor measurement and communicating (via wireless or wired communications medium) with any other sensing device within its maximum communications range. Each sensing device also includes a processor (101ᵢ-101ₙ) and memory for executing/storing a set of instructions.

FIG. 2 is a high-level flowchart of steps performed by each sensing device in order create a sensor network, preferably a network that can be represented by a connectivity graph that is strongly connected, i.e. there exists a path from every vertex to every vertex such that every sensing device is capable of communicating with all other sensing devices via multi-hop routing. At step 202, subsets of the sensing devices are identified, with each of the subsets providing a preferred sensing quality coverage. For example, out of the six sensors shown in FIG. 1, sensing devices Sᵢ, Sⱼ, Sₖ may form one subset that meets the coverage criteria. One example of a function for determining sensing quality coverage defined as the maximum sensing quality coverage will be described below, but it will be appreciated that the technique described herein can be adapted to meet any sensing quality function. Typically, subsets including all of the plurality of sensing device will be identified, but it will be appreciated that in some cases only some of the sensing device may be considered.

At step 204, the communications signals of the sensing devices in the subsets are adjusted to seek to enable communication between the sensing devices in all of the plurality of subsets (thereby creating a sensor network that can be represented by a connectivity graph that is strongly connected). An example of a strength adjustment technique will be given below. Typically, all of the identified subsets will be involved in step 204, but in some cases only some of the subsets may be considered.

At step 206 frequencies are allocated to the (active) sensing devices in the subsets. As will be discussed below, a known graph colouring algorithm, such as an ∈ₙ-greedy algorithm, can be applied to colour the graphs and effectively allocate the frequencies in a decentralised fashion. This means that for subsets containing three devices, only six different frequencies are required to avoid interference. It will be appreciated that an alternative to the ∈ₙ-greedy algorithm could be used, such as one based on the known Branch-and-Bound, backtracking and Max-Sum techniques.

Detailed examples of these high-level steps, along with mathematical/Graph Theory descriptions, will be given below.

Let S={Sᵢ, . . . , S_{M}} denote a set of M sensors deployed on the R² plane.

The Cartesian coordinates are given by a vector xᵢ=(xᵢ,yᵢ). Let d(xᵢ,xⱼ) denote the Euclidean distance between Sᵢ and Sⱼ. Each sensor Sᵢ has a radio disk with radius rᵢ within which other sensors can receive their transmissions. Consequently sensor Sⱼ can receive Sᵢ's transmissions if Sⱼ is contained within Sᵢ's radio disk: d(xᵢ,xⱼ)≦rᵢ. Each sensor Sᵢ has control over its transmission radius rᵢ, which it set anywhere between 0 and rₘₐₓ, which is the maximum transmission radius for all sensors. Given this model, it is possible to construct a connectivity graph that models the communication network that exists among the sensors. A sensor connectivity graph C[S] can be considered to comprise a set of sensors S in a directed graph C[S]=(S,E) in which E contains a pair of sensors (Sᵢ,Sⱼ) if Sⱼ can receive Sᵢ's transmissions.

To ensure transmissions between two sensors are not compromised by interference from other sensors, it is desirable to allocate frequencies to each sensor such that no two sensors with overlapping radio disks are allocated the same transmission frequency. However, the connectivity graph C[S] only models direct collisions, which are those that occur between Sᵢ and Sⱼ if they are contained within each other's radio disks; it does not model the possibilty of indirect collisions, which occur when two sensors Sᵢ and Sₖ are not contained within each other's radio disks, but there exists a sensor S that is contained in both. When indirect collisions occur, sensor Sₖ will receive garbled transmissions from Sᵢ and Sⱼ. A collision graph C²[S] of sensors S is the square of C[S], denoted by C²[S]. This graph contains an edge (Sᵢ,Sⱼ) if there exists a path between Sᵢ and Sⱼ in C[S] of at most two edges.

By effectively connecting neighbours of neighbours in the connectivity graph C[S], the collision graph C²[S] models the possibility of direct as well as indirect collisions. Thus, solving the frequency allocation problem is equivalent to colouring C²[S], which is a known NP-complete problem. To bound the number of required colours needed to colour the graph (also referred to as the chromatic number), which can be very large on an arbitrary sensor network, and also in the interest of keeping the sensors as simple and robust as possible, the overall technique can be divided into two steps. First, it finds a set of sensors whose connectivity graph C[S] is easily colourable. More specifically, the connectivity graph is triangle-free. A triangle-free graph is a graph that does not contain any cycles of length 3, or equivalently, whose maximum clique size is 2. A 3-colouring of a triangle-free graph is guaranteed to exist [C. Thomassen, Grotzsch's 3-color theorem and its counterparts for the torus and the projective plane, Jounal of Combinatorial Theory, Series B, 62(2):268-279, 1994], and can be computed in linear time [Z. Dvorak, K. Kawarbayashi and R. Thomas. Three-coloring triangle-free planar graphs in linear time. In SODA '09: Proc. Of the Nineteenth Annual ACM—SIAM Symposium on Discrete Algorithms, pages 182-196, 2007]. This colouring avoids any direct collisions. The second step attempts to avoid any indirect collisions by considering the denser collision graph of this triangle-free connectivity graph. Simple graph theory shows that this graph is guaranteed to be K₇ minor-free, based on the triangle-free property of the connectivity graph. By exploiting this property, and applying the well-known Hadwiger conjecture, it can be determined that the obtained collision graph is 6-colourable. Thus, the maximum number of colours needed to colour the collision graph of a triangle-free connectivity graph is 6.

Besides ensuring reliable communication between the sensors, it is also desired to maximise, or at least increase, the sensing quality that the sensor network provides. The sensing quality can be given by a submodular set function: f:2^{E}→R defined over a finite set E and is called submodular if for A ⊂B⊂E and e∈E, f (A+e)−F(A)≧F(B+e)−F(B).

In more detail, sensing quality achieved by a subset of S is given by a non-decreasing submodular function f:2^{S}→R. Intuitively, function f defines the diminishing returns of adding an extra sensor to an existing sensor network. Thus, the problem can be thought of as how to find a set S′⊂S that maximises f (S′) subject to C[S′] being triangle-free. These sensors S′ will then form the new sensor network, by deactivating sensors S\ S′.

Additionally, the technique can take into account the fact that sensors can fail. One major cause of sensor failure is battery depletion. Herein, it is assumed that radio transmission accounts for the majority of the energy consumption of the sensor (and not the energy required for sensing). Sensors can be though of as having an initial battery capacity bᵢ, which reduces over time as a result of their transmission power as follows: Δbᵢ=r²ᵢ·Δt.

A centralised greedy technique with theoretical bounds on the solution is first described below and intended to act as a benchmark for the decentralised technique described afterwards. Both techniques activate a subset of the deployed sensors whose connectivity graph is not necessarily connected. As a result, sensors will not always be able to communicate their measurements to a base station. Therefore, the decentralised technique attempts to reconnect the various components of the graph by incrementally increasing their communication range.

The centralised greedy algorithm is based on the notion of independence systems from combinatorial optimisation. An independence system is a pair (E,I), where E is a finite set of elements, and I is a collection of subsets of E such that if A∈I and B c A, then B⊂I. Sets in I are said to be independent.

The set I_{Δ-free} of subset of S whose connectivity graph is triangle-free form an independence system, since every induced subgraph of a triangle-free graph is triangle-free. Since not every subset is equal in terms of sensing quality, these independence systems are augmented with the submodular function f that measures sensing quality. A submodular independence system is an independence system together with a non-decreasing submodular set functions f. Unfortunately, for a submodular independence system, finding a set I*∈I such that I*=arg max_{I∈I}f (I) is an NP-hard problem. Therefore, under the assumption that P≠NP, there does not exist a polynomial time algorithm for computing I*. As a result, to obtain solutions that scale will with the size of the sensor network the technique employs approximation. A simple approximation algorithms in the greedy Algorithm 1 below, which builds a solution without backtracking by iteratively adding those elements that most improve the solution (with respect to f), while simultaneously satisfying an independence constraint.

The greedy algorithm computes a maximal independent set, which is an independent set I such that by adding any e∈E\I, it becomes dependent. In other words, no sensor can be added to the sensor network without introducing a triangle.

Algorithm 1: Greedy algorithm for a submodular independence system
((E, I ), f, )

1: I := ø
2: while E ≠ ø do
3: e* := arg max_{eε E}f (I + e) − f (I)
4: E := E − e*
5: if I + e* ε I then
6: I := I + e*
7: end if
8: end while
9: return I

While the greedy algorithm above is simple, it has its drawbacks: a main one being that it can perform arbitrarily badly, as illustrated by the following example:

Let E={A,B₁, . . . , B_{M}}, I={{B₁, . . . , B_{M}}, {A}}, and f ({A})=n f ({Bᵢ})=n−∈, f ({B₁, . . . , B_{M}}=(n−∈)M. When M→∞ and ∈→0, the approximation ratio for Algorithm 1, i.e. f (I)/f (I*), approaches 0. In other words, for arbitrary independence systems, the greedy solution can be arbitrarily far away from the optimal solution.

Fortunately, many independence systems exhibit additional structure that can be exploited to obtain a lower bound on the approximation ratio for Algorithm 1. The notion of p-independence is one of these [G. Calinescu, C. Chekuri, M. Pal and J. Vondrak. Maximising a submodular set function subject to a matroid constraint. In IPCO '07: Proceedings of the 12^{th} international conference on Integer Programming and Combinatorial Optimisation, pages 182-196, 2007]. An independence system (E, I) is called p-independent if for all A∈I and e∈E there exists a set B⊂A such that |B|≦p and A\B+e∈I

The following is a result in Combinatorics that proves a lower bound on the approximation ratio of the greedy algorithm: Algorithm 1 yields a 1/(1+p)−approximation to maximising a non-decreasing submodular set function subject to a p-independence constraint.

Thus, to obtain a lower bound on the greedy algorithm for the sensor coverage problem, it is necessary to determine p for (S, I_{Δ-free}). In order to do so, the problem defined is restricted slightly. This restriction involves limiting the radius of the radio disks to a constant R for every sensor. A set of sensors with a fixed radio range R is denoted as S_{R}, and the connectivity graph obtained is called a unit disk graph. This construct makes it possible to prove the following theorem: System (S_{R}, I_{Δ-free}) is 6-independent. A proof for this theorem is as follows: simple geometry shows that the maximum degree of a triangle-free unit disk graph no larger than 11. Let A be a valid solution (i.e. A ∈I). Now, deg(e)≦11 in A+e, otherwise A∉I. When deg(e)=11, A+e contains 11 triangles. To break each of these, p=[11/2]=6 vertices are removed from A. Let B denote this set of vertices. Then A\B+e∈I with |B|≦6, as required.

FIG. 3 shows a visual representation of this proof. In this Figure, e is the black vertex 302, B is represented by the white vertices 304 and A is represented by the white and gray vertices 306. Radio disks are represented by gray circles 308. (For ease of exposition, these radio disks have been scaled by 50%. As a result, links exist within this unit disk graph when the scaled disks overlap).

As a result of the above theorem, the greedy algorithm is guaranteed to produce a solution I such that f (I)/f(I*)≧1/7 for system (S_{R}, I_{Δ-free}). However, it is not known whether or not this lower bound is tight. For example, note that in the worst case, greedy yields a 6/11 approximation on the construction used in the proofs. Moreover, the empirical evaluation (see below) obtained approximation ratios no less than 75%, even without the requirement that rᵢ=R for all i.

The above technique assumes the existence of a centralised controller that has perfect knowledge of function f, set E and has a way of determining whether the resulting graph is triangle-free. However, when a centralised controller is absent, sensors do not have access to the global knowledge required to execute the greedy algorithm in a purely decentralised fashion. While it might be possible to construct a decentralised algorithm that shares all required information, this would require excessive communication between sensors. Therefore, the preferred technique takes a different approach and develops an effective approximate decentralised algorithm that requires very limited local communication. In more detail, embodiments of this technique allows sensors to construct a triangle-free network by inspecting their neighbourhood. That is, if the neighbourhood of all sensing agents is triangle-free, the connectivity graph is triangle-free.

No more than two sensors within a clique can be activated without creating a triangle. A key challenge is therefore to find which two sensors should be activated to maximise sensing quality. Solving this problem optimally in a central fashion is NP-hard and so solving it optimally in a decentralised fashion is at least as hard. Therefore, approximation is again used in the form of a greedy decentralised technique. Using this technique, sensors are able to coordinate with their neighbours to identify the sensors that maximise coverage within that clique. In more detail, when performing this technique, each sensor Sᵢ continually checks whether a pair of sensors (Sᵢ, Sₖ) exist within the same clique, such that the coverage provided by (Sᵢ, Sₖ) is greater than the coverage provided by either (Sᵢ, Sⱼ) and (Sᵢ, Sₖ). If this is discovered to be the case, Sᵢ is said to be “dominated”. In all other cases, Sᵢ is said to be “dominating”. In the former case, activating the sensor would result in suboptimal sensing quality, and the sensor would turn itself off. Similarly, in the latter it is better to activate the sensor.

Algorithm 2 The Distributed Greedy Algorithm for Sᵢ

1: State ← BASIC
2: Sᵢ^{B} ← adj (Sᵢ)
3: Broadcast <i, Sᵢ^{B}>
4: Receive <j, Sⱼ^{B})> for all Sⱼ ε adj(Sᵢ)
5: while State = BASIC do
6: On random activation
7: Sᵢ^{B} ← {S | S ε Sᵢ^{B} [symbol] State(S) ≠ DOMINATED}
8: if ∃j : Sᵢ^{B} ∩ Sⱼ^{B} ≠ ø then
9: Randomly select Sₖ ε Sᵢ^{B} ∩ Sⱼ^{B}
10: fⱼₖ ← f ({Sⱼ, Sₖ})
11: if fⱼₖ ≧ f ({Sᵢ, Sⱼ}) and fⱼₖ ≧ f ({Sⱼ, Sₖ}) then
12: State ← DOMINATED
13: end if
14: else
15: State ← DOMINATING
16: end if
17: Send <i, State> to all Sⱼ ε adj(Sᵢ)
18: end while

In more detail, the Algorithm 2 above captures the necessary steps to determine the status of a sensor. Before starting the main while loop, neighbours are discovered by means of message passing (lines 3 and 4). Then, in lines 7 and 8 the sensor attempts to find a non-dominated neighbour that in turn has a non-dominated neighbour in common with itself (i.e. a triangle). If no such neighbour can be found, the sensor's best strategy is to turn itself on (line 15). If, however, such a neighbour does exist, at least one of these three sensors needs to turn off in order to ensure that the graph is triangle-free. Therefore, in line 11, the algorithm checks whether turning itself on is a dominated strategy. If this is the case, the sensor sets its state to dominated and notifies its neighbours of its updated status, and turns itself off (line 12).

A sensor is capable of detecting termination of this algorithm by inspecting the states of its neighbours: if all neighbours are either dominated or dominating, the algorithm has terminated. Termination of this algorithm is guaranteed: when the number of iterations approaches infinity, a dominated sensor will select Sₖ in Line 9, such that (Sᵢ, Sₖ) with probability 1, and deactivate itself. All dominating sensors will remain in the BASIC state, until all dominated sensors have deactivated themselves. At this point, dominating sensors will no longer be able to find a triangle (line 8), and thus detect their dominating state (line 15).

FIG. 4 is a flowchart showing an implementation based around Algorithm 2 that can be executed once, periodically or continually by the plurality of sensing devices in order to allocate frequencies in a non-interfering manner. In the example of FIG. 4, sensing device Sᵢ is executing the technique and at step 402, its processor 101ᵢ checks whether there is a non-dominated neighbouring sensing device, e.g. Sⱼ, that has a non-dominated neighbour, e.g. Sₖ, in common with Sᵢ. If this is found not to be the case (i.e. Sᵢ is not part of a triangle; in other words all sensors around it, except one are “Dominated”) then at step 404 the state of Sᵢ is set as “Dominating” and it is activated for network communications (at least).

If the question asked at step 402 is answered in the positive then control passes on to step 406, where a check is performed as to whether the coverage provided by sensing device pair Sⱼ, Sₖ is greater than that provided by pair Sᵢ, Sⱼ and also greater than that provided by pair Sᵢ, Sₖ. If this is the case then at step 408 the state of device Sᵢ is set to “Dominated” and the device is de-activated for network communications (at least); otherwise, control is passed back to step 402 so that the process is re-started. Having the plurality of sensing devices execute this technique results in a selection of subsets, each of which comprises an activated, dominating sensing device, which together may be used to form the sensor network.

The two greedy algorithms described above compute a triangle-free subgraph of C[S] with high sensing quality. However, these induced subgraphs are not necessarily strongly connected, since they only satisfy the requirement that they are triangle-free (cycle-free). A further phase therefore attempts to reconnect different components of the computed subgraph. This technique is not always capable of fully reconnecting the graph as the maximum radio transmission range rₘₐₓ is sometimes insufficient. However, even when it is not completely successful it manages to increase the size of the maximum connected component significantly.

To attempt to reconnect the graph, sensors incrementally boost their communications, e.g. radio, signals to connect with sensors that were previously unreachable. It is undesirable for sensor to set their signal strength to the maximum setting, for two reasons. First, it will drain their battery quickly (with a rate of r²ₘₐₓ), thereby reducing the operation time of the sensor network as a whole. Second, by increasing the radius of its radio disk, a sensor might introduce additional edges that create a triangle, which was to be avoided. Therefore, in order to connect to additional sensors whilst maintaining a triangle-free graph, each sensor can individually execute Algorithm 3 below, which relies on local computation and communication only.

Algorithm 3 The Reconnection Algorithm

1: repeat
2: Broadcast <i, adj(Sᵢ)>
3: Receive <j, Sⱼ)> for all Sⱼ ε adj(Sᵢ)
4: rᵢ ← c · rᵢ
5: until adj(Sᵢ) ∩ adj(Sⱼ) ≠ ø or rᵢ > rₘₐₓ
6: rᵢ ← rᵢ /√c

This algorithm preserves the triangle-free property of the first connectivity graph by continually checking whether a neighbouring sensor share a common neighbour. If it is discovered that this is the case (line 5), the graph contains a triangle, at which point both neighbours reduce their radio range in order to break it (line 6). The skilled person will appreciate that alternatives to this technique are possible, e.g. the signal strength could initially be set at the maximum range and be decremented until no common neighbour is detected.

FIG. 5 is a flowchart showing an implementation based around Algorithm 3 above that can be executed continually by the plurality of sensing devices after performing the steps of FIG. 4. At step 502 the sensing device incrementally increases the strength of its communication signal (within its predetermined maximum range). At step 504, the device checks whether it has a neighbouring sensing device with which it shares a common neighbouring sensing device. If the result of this check is negative then control passes back to step 502; otherwise, at step 506, the most recent incremental increase of the signal strength is reversed/undone.

To illustrate the reconnection technique, FIGS. 6(a)-6(c) show the output of the centralised algorithm for an example sensor deployment with M=100 sensors. In this example, sensor quality is represented by different sized sensing disks. Phase 1 selects a subgraph that consists of 8 components. Phase 2 reconnects these components effectively whilst ensuring that the resulting connectivity graph remains triangle-free. The circle 602 represents the sensing areas of the sensor 604. An edge between two sensors indicates that communication is possible. A particularly attractive feature of the selected sensors, is that their connectivity graph is colourable with three colours, and their collision graph with six colours (as discussed above), while the original connectivity graph (in this particular case) needed 23 colours (so its collision graph would probably required much more than 23 colours). FIG. 6(b) shows the sensors selected by the centralised technique and FIG. 6(c) is a connectivity graph after application of the reconnection technique.

In the above examples, the techniques are performed a one-off optimisation procedure in order to activate a subset of the sensing devices that provide high sensing quality. It is possible to modify the technique to deal with a more dynamic setting, where deployed sensors can fail and/or new sensors can be deployed. Embodiments of the technique can continuously monitor the sensor network and select replacements for sensors that stop functioning.

A key property of the centralised greedy algorithm is that it selects the sensors that most improve the already constructed solution. So, once a sensor fails, Algorithm 1 is run again. However, instead of initialising Ito the empty set in line 1, I is initialised to the already computed subset, minus the failing sensors. Furthermore, E is initialised to E minus all active and failed sensors. The algorithm will then proceed to iteratively add new sensors (if possible). Should new sensors be deployed, these are simply added to E, and the algorithm will run as before.

For the decentralised technique described above, instead of completely turning off Dominated sensors, these sensors are configured keep monitoring communication in their neighbourhood. Once a neighbouring sensor fails (which can be detected by a prolonged interval of communication silence), it resets its state to BASIC, and runs Algorithm 2 again. Active sensors (i.e. those with a Dominating state) need not re-run the algorithm. Should new sensors be deployed, they will be treated as Dominated sensors.

FIG. 7 is a flowchart showing an implementation of the above steps that can be executed continually by at least some of the non-dominated sensing devices. If a sensing device detects that a neighbour has failed (step 702) the state of the (non-failed) sensing device is reset from Dominated to BASIC (step 704) and then Algorithm 2 is run again (step 706).

A description of an experimental evaluation of the techniques discussed above in a large scale sensor deployment scenario will now be described. To empirically evaluate the techniques a scenario in which M sensors were randomly deployed in a unit square and tasked with event detection was considered. The area in which sensor Sᵢ can detect an event is a disk with radius sᵢ, which is drawn from the interval [0.05, 0.2] with uniform likelihood. The radius rᵢ within which sensor Sᵢ can receive and send transmissions is uniformly drawn from the interval [0.5R,R]. Moreover, the maximum radio transmission range is rₘₐₓ=1.2R. Events occur randomly within the unit square with uniform probability. The sensing quality f (S′) achieved by a subset S′⊂S is the expected number of detected events i.e. those that fall within the sensing disk of at least one sensor.

More formally, let ∇ (Sᵢ) denote the sensing area of sensor Sᵢ, i.e. ∇: S→2^{R}^{²}. Moreover, let μ(.) denote the measure of an area, i.e. μ: 2^{R}^{²}→R. Now, function f is defined as:

$$\begin{matrix}f ( {S}^{′} + S ) - f ( {S}^{′} ) = μ ( {⋃}_{\tilde{S} ∈ {S}^{′} + S} ∇ ( \tilde{S} ) ) - μ ( {⋃}_{\tilde{S} ∈ {S}^{′}} ∇ ( \tilde{S} ) ) \\ = μ ( ∇ ( S ) \backslash ( ∇ ( S ) ⋂ {⋃}_{\tilde{S} ∈ {S}^{′}} ∇ ( \tilde{S} ) ) ) \leq \\ μ ( ∇ ( S ) \backslash ( ∇ ( S ) ⋂ {⋃}_{\tilde{S} ∈ {S}^{′′}} ∇ ( \tilde{S} ) ) ) \\ = f ( {S}^{′′} + S ) - f ( {S}^{′′} )\end{matrix} \qquad ( 2 )$$

The theorem Function f is a non-decreasing submodular set function can be proven as follows: the non-decreasing property of f follows trivially from the fact that adding a sensing area can never reduce the total sensing covering. To see that f is submodular, observe that:

$$f ( S ) = μ ( {⋃}_{S ∈ S} ∇ ( S ) ) \qquad ( 1 )$$

For the first set of experiments, the centralised and decentralised greedy techniques describe above were applied to a sensor deployment with M=300. The sensing range for each sensor was uniformly drawn from [0.05, 0.2], while the radio range was uniformly drawn from [0.5R, 1.0R]. During the experiments, R was varied between 0.1 and 0.5 to determine the effect of different levels of density in the connectivity graph C[S]. The techniques were benchmarked against an optimal algorithm that computes a triangle-free subgraph with optimal coverage. This algorithm uses branch and bound and exploits the structure of submodular functions to improve computational efficiency. Despite these computational efficiency improvements, however, such an optional approach does not scale beyond ≈30 sensors. Because of this, two batches of experiments were performed. In the first, 30 sensors were used to evaluate the centralised, decentralised and optimal algorithms, and in the second batch the centralised and decentralised algorithms were applied to a deployment of 300 sensors.

The sensing coverage of the selected sensors computed by both centralised and the decentralised algorithms as a fraction of the sensing coverage of all sensors was measured. Moreover, in order to determine the effectiveness of the reconnection algorithm, the coverage achieved by the largest connected component of the graph was also measured. This metric captures the trade-off between the graph connectedness and sensing quality. Finally, the number of selected sensors was measured.

The results of the first batch are summarised in FIGS. 8(a)-8(c). FIG. 8(a) shows the sensing quality as a fraction of the sensing quality achieved by all M (30) sensors. This plot shows that the difference between the optimal solution and the solution computed by both greedy algorithms is less that 10% in the most constrained case (i.e. R=0.5). This is a clear indication that both greedy algorithms compute very good approximations, without the need for exhaustively searching the solution space. The error bars indicate the error of the mean. FIG. 8(b) shows the sensing quality achieved by the largest component. In this Figure, the postfix ‘no RC’ indicates that the reconnection technique describe above was not used. The Figure demonstrates the effectiveness of the reconnection technique; it manages to connect a sufficient number of components to almost double the sensing quality of the largest component of the graph. FIG. 8(c) shows that the optimal algorithm manages to select a small number of extra sensors compared to both greedy algorithms. As expected both greedy algorithms are less successful in satisfying the independence constraints while maximizing sensor coverage. However, this effect is only marginal, since the optimal algorithm selects just 10% more sensors than the decentralised greedy algorithm.

The results of the second batch are shown in FIGS. 9(a)-9(c), where M=300. Overall, the same features as before can be observed here. However, FIG. 9(a) shows that the achieved coverage of the decentralised algorithm drops below 60% of the maximum achievable coverage for R=0.5. The same—albeit less strong—effect can be observed for the centralised greedy algorithm. However, note that for this level of radio range, the sensors cover around a quarter of the entire area. As a result, the connectivity graph of the original sensor network is very dense, and by limiting the solution to triangle-free graphs the problem is very constrained. FIG. 9(b) again demonstrates the effectiveness of the reconnection algorithm, but also that between R=0.1 and R=0.3 both algorithms provide at least 85% of the maximum possible sensor coverage, while needing approximately half (for R=0.1) to a tenth for (R=0.3) of the available sensors.

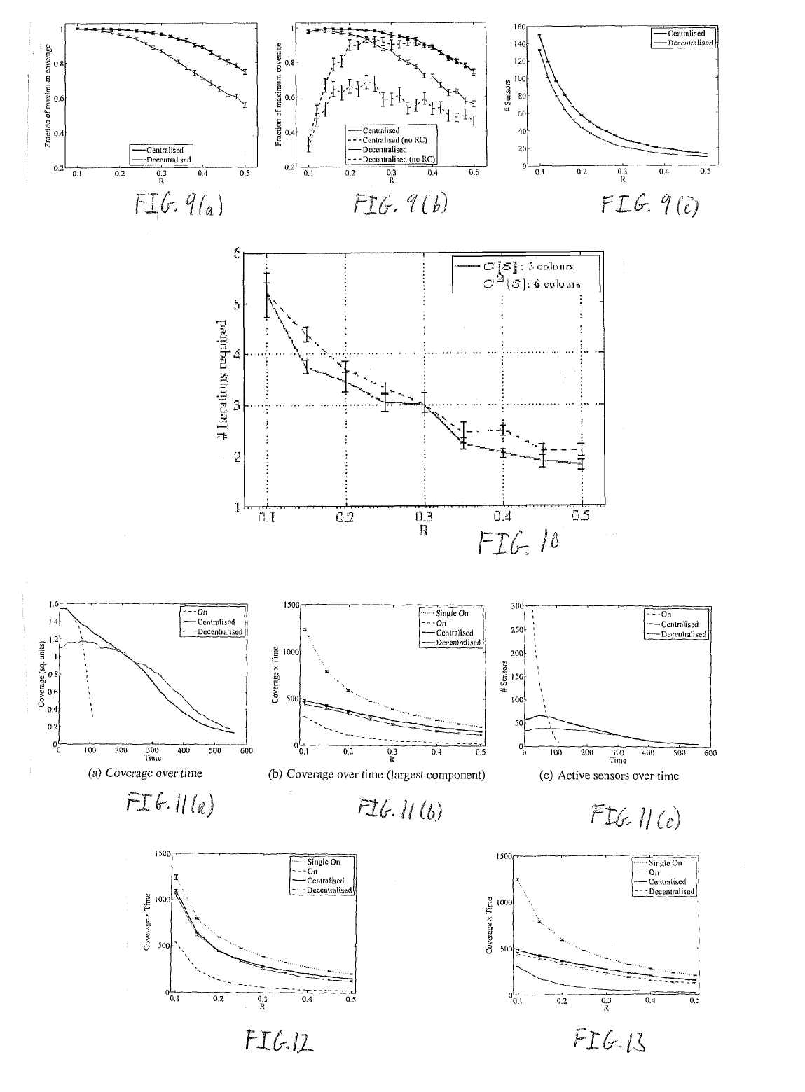

Finally, to corroborate the theoretical result that the resulting connectivity and collision graphs are easily 3 and 6-colourable respectively (as mentioned above), a simple and standard algorithm was used to colour the graphs in a decentralised fashion. This algorithm is an ∈ₙ-greedy algorithm, i.e. with probability 1−∈ₙ it selects the colour that minimises the number of mono-chromatic edges, while with probability ∈ₙ it picks a random colour. Furthermore, probability ∈ₙ decreases with each iteration of the algorithm as ∈ₙ←n^{n−1}∈ₙ, where n is the iteration number. Given this context, FIG. 10 shows that colouring the resulting graphs in a decentralised fashion is indeed trivial: for 300 sensors, the algorithm needs five iterations on average to correctly colour both types of graphs. Moreover, this simple algorithm managed to find a colouring in all 5000 considered problem instances.

For a second experiment, the dynamic greedy algorithms were evaluated. To do this, randomly deployed sensor networks were deployed as above. However, sensor failures also needed to be considered. In the simulations, sensors are deactivated as they completely deplete their battery. Initially, every sensor Sᵢ has a battery capacity bᵢ of 1 unit. The battery depletion rate is modelled as Δbᵢ=−rᵢ²·Δt. Each time a sensor fails, the techniques described above attempt to replace it with sensors that were not selected for the initial deployment. This technique was benchmarked against a naïve strategy (referred to as ‘On’) in which all sensors are activated upon deployment.

The results are shown in FIGS. 11(a)-11(c), where M=300 and R=0.2. The plots in FIGS. 11(a) and 11(b) show the coverage over time achieved by all active sensors and the largest component respectively. Clearly, the sensing quality provided by the ‘On’ strategy rapidly decreases, since all sensors are activated, and the sensing areas overlap, causing redundancy. Compared to ‘On’ the triangle-free and decentralised algorithms perform notably better. Moreover, whereas the decentralised algorithm is outperformed by the centralised one for the initial sensor deployment (cf. FIGS. 9(a) and 9(b)), the decentralised algorithm starts outperforming its centralised counterpart after t≈250. The explanation for this is found in FIG. 11(c), which shows the number of active sensors over time: the decentralised algorithm requires fewer sensors for the initial deployment, and therefore has more sensors available to replace failed ones.

Finally, the total sensor coverage provided over time was recorded for several radio ranges R. Sensor coverage over time is defined as the area of the region below the graphs shown in FIGS. 11(a) and 11(b). For this experiment, an additional benchmark strategy that activates only a single sensor at a time (referred to as ‘Single On’) was used. The performance of this strategy acts as an upper bound on the total coverage over time that can be achieved, since no two sensors redundantly cover the space. FIG. 12 (total coverage over time) and FIG. 13 (total coverage over time provided by largest component) show the results. These Figures confirm that ‘On’ is outperformed by both greedy algorithms for several values of R, and by around 250% for R=0.2N. Moreover, by comparing the performance of our algorithms to that of ‘Single On’, it can be seen that these algorithms manage quite effectively to minimise redundant coverage, since ‘Single On’ has no redundant coverage by its very nature. An important conclusion drawn from these experiments, however, is that the decentralised algorithm achieves at least 80% of the sensing quality of the centralised greedy algorithm (92% for R=0.2N), while only requiring local communication and computation.

The experiments show that the selected sensors manage to achieve 90% of the coverage provided by the optimal algorithm, and 85% of the coverage provided by activating all sensors. Equally important, the frequency assignment problem in the resulting sensor network can be solved by a simple decentralised graph colouring algorithm.

It will be appreciated that versions of the above techniques may be applicable to passive mobile sensors. These are sensors that are moved by forces beyond their control, such as wind or water. Since the connectivity graph will be subject to constant change, the computed subgraph of the sensor network might have to be periodically revised. Furthermore, decentralised scheduling algorithms (e.g. as described in A. Farinelli. A. Rogers and N. Jennings. Maximising sensor networks efficiency through agent-based coordination of sense/sleep schedules. In Workshop on Energy in Wireless Sensor Networks in conjunction with DCOSS, 2008) could be used to reduce redundant coverage by overlapping sensing areas, which may improve the lifetime of the network even further.

1. A method of creating a sensor network from a plurality of sensing devices, the method comprising:
identifying a plurality of subsets of the sensing devices, each of the subsets providing sensing quality coverage; and
adjusting communication signal strengths of the sensing devices in the subsets to seek to enable direct or indirect communication between active sensing devices in all of the plurality of subsets, thereby creating a sensor network.

2. A method according to claim 1, wherein the identifying of a subset including a first sensing device comprises:
identifying two neighbouring sensing devices of the first sensing device.

3. A method according to claim 2, comprising:
identifying one of the sensing devices within a subset that is determined to be dominated by two other sensing devices in the subset; and
deactivating at least network communication of the dominated sensing device.

4. A method according to claim 3, comprising:
determining that a first sensing device in a subset is dominated if a sensing quality coverage provided by a pair consisting of two other sensing devices in the subset is greater than a sensing quality coverage provided by a pair consisting of the first sensing device and either of the two other sensing devices in the subset.

5. A method according to claim 4, wherein a subset having a desired sensing quality coverage comprises:
a subset having said first sensing device that is dominated by the two other sensing devices in the subset.

6. A method according to claim 1, wherein a subset is represented by a triangle-free sub-graph of a connectivity graph representing the plurality of sensing devices.

7. A method according to claim 1, comprising:
allocating frequencies to the sensing devices in each said subset.

8. A method according to claim 7, wherein frequencies allocated to the sensing devices are selected from a set comprising six different frequencies, with each of the sensing devices being allocated a particular one of the frequencies.

9. A method according to claim 1, wherein the adjusting communication signal strengths of the sensing devices comprises:
incrementally increasing for at least one of the sensing devices a strength of its communication signal within a specified maximum range until the sensing device detects that it and a neighbouring sensing device share a common further neighbouring sensing device; and
subsequently reversing/undoing a preceding incremental increase of the signal strength of the sensing device.

10. A method according to claim 4, comprising:
setting, if a non-dominated sensing device detects that a neighbouring sensing device has failed, a state of the non-dominated sensing device as undecided instead of non-dominated so that its state can be re-determined.

11. A sensor network system, comprising:
a plurality of sensing devices, wherein at least one of the sensing devices each includes:
a processor configured to identify a plurality of subsets of the sensing devices, each of the subsets providing a sensing quality coverage; and
a processor configured to adjust communication signal strengths of the sensing devices in the subsets to seek to enable direct or indirect communication between active said sensing devices in all of the plurality of subsets, thereby creating a sensor network.

12. A system according to claim 11, wherein the sensing devices communicate without reliance upon a centralised controller that has knowledge of coverage and states of the sensing devices.

13. A sensing device comprising:
a processor configured to:
identify a subset including the sensing device and at least one other sensing device, the subsets providing a sensing quality coverage; and
adjust a communication signal strength of the sensing devices to seek to enable direct or indirect communication between active sensing devices in a plurality of subsets of sensing devices, thereby creating a sensor network.

14. A computer program product, comprising:
a non-transistory computer readable medium, having stored thereon computer program code such that, when the program code is loaded, will cause the computer execute a method creating a sensor network from a plurality of sensing devices, the method comprising:
identifying a plurality of subsets of the sensing devices, each of the subsets providing a sensing quality coverage; and
adjusting communication signal strengths of the sensing devices in the subsets to seek to enable direct or indirect communication between active sensing devices in all of the plurality of subsets, thereby creating a sensor network.

15. A method of selecting sensors for use in a sensor network, the method comprising:
providing a plurality of sensors; and
identifying subsets of sensors from the plurality of sensors, each said subset having a connectivity graph that is triangle-free.
